(19) United States
(12) Patent Application Publication
(10) Pub. No.: US 2008/0109435 A1
(43) Pub. Date: May 8, 2008

(54) Determining Sort Order by Traffic Volume

(75) Inventor: R. Todd Stephens, Sharpsburg, GA (US)

Correspondence Address: THOMAS, KAYDEN, HORSTEMEYER & RISLEY, LLP/;AT&T Delaware Intellectual Property, Inc., 600 GALLERIA PARKWAY, S.E., SUITE 1500, ATLANTA, GA, 30339-5994, US

(73) Assignee: BELLSOUTH INTELLECTUAL PROPERTY CORPORATION, Wilmington, DE (US)

(21) Appl. No.: 11/557,325

(22) Filed: Nov. 7, 2006

(51) Int. Cl. G06F 7/08

(52) U.S. Cl. 707/7

(57) ABSTRACT

Included are embodiments for determining a sort order. At least one embodiment of a method includes determining at least one search result from received search criteria, the at least one search result being related to a first web page and determining web page traffic data associated with the first web page, the web page traffic data being related to at least one user action associated with the first web page. Some embodiments include determining a display order for the at least one search result from the web page traffic data.

### CROSS REFERENCE

This application is related to U.S. patent application Ser. No. ______, entitled “Determining Sort Order by Distance” and U.S. patent application Ser. No. ______, entitled “Topic Map for Navigation Control,” which are filed on the same day as this application and which are both incorporated by reference in their entireties.

### TECHNICAL FIELD

This disclosure relates to determining a sort order for at least one search result. More specifically, this disclosure relates to determining a sort order based on previous traffic volume.

### BACKGROUND

As the number of web pages increases (either on the Internet as a whole, on an Intranet, and/or on a particular website), users may have difficulty locating a web page that is pertinent to desired information. To combat this problem, websites have emerged that provide searching capabilities. These “search engines” may be configured to provide search options for locating desired data on the Internet (and/or Intranet). To provide these search options, search engines often utilize search algorithms for locating desired web pages. Once a collection of web pages is determined, many search engines determine a display order for the search results.

While many search engines determine display order based on the number of links on a web page and/or the number of occurrences of the search term within the body of the web page, these criteria oftentimes do not provide a display order with the most relevant search results being most accessible to the user. More specifically, a search engine may utilize predictive algorithms to determine web pages that might be relevant. As such, the user may be forced to sort through numerous search results before locating a web page that actually includes the desired information. The user may thus miss the most relevant web page to the search terms provided to the search engine.

Thus, a heretofore unaddressed need exists in the industry to address the aforementioned deficiencies and inadequacies.

### SUMMARY

Included are embodiments for determining a sort order. At least one embodiment of a method includes determining at least one search result from received search criteria, the at least one search result being related to a first web page and determining web page traffic data associated with the first web page, the web page traffic data being related to at least one user action associated with the first web page. Some embodiments include determining a display order for the at least one search result from the web page traffic data.

Also included are embodiments of a system for determining a sort order. At least one embodiment includes a result determining component configured to determine at least one search result from received search criteria, the at least one search result being related to a first web page. Some embodiments include a traffic determining component configured to determine web page traffic data associated with the first web page, the web page traffic data being related to at least one user action associated with the first web page. Some embodiment include an order determining component configured to determine a display order for the at least one search result from the web page traffic data.

Also included are embodiments of a computer readable medium for determining a sort order. At least one embodiment includes result determining logic configured to determine at least one search result from received search criteria, the at least one search result being related to a first web page. Some embodiments include traffic determining logic configured to determine web page traffic data associated with the first web page, the web page traffic data being related to at least one user action associated with the first web page. Some embodiments include order determining logic configured to determine a display order for the at least one search result from the web page traffic data.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

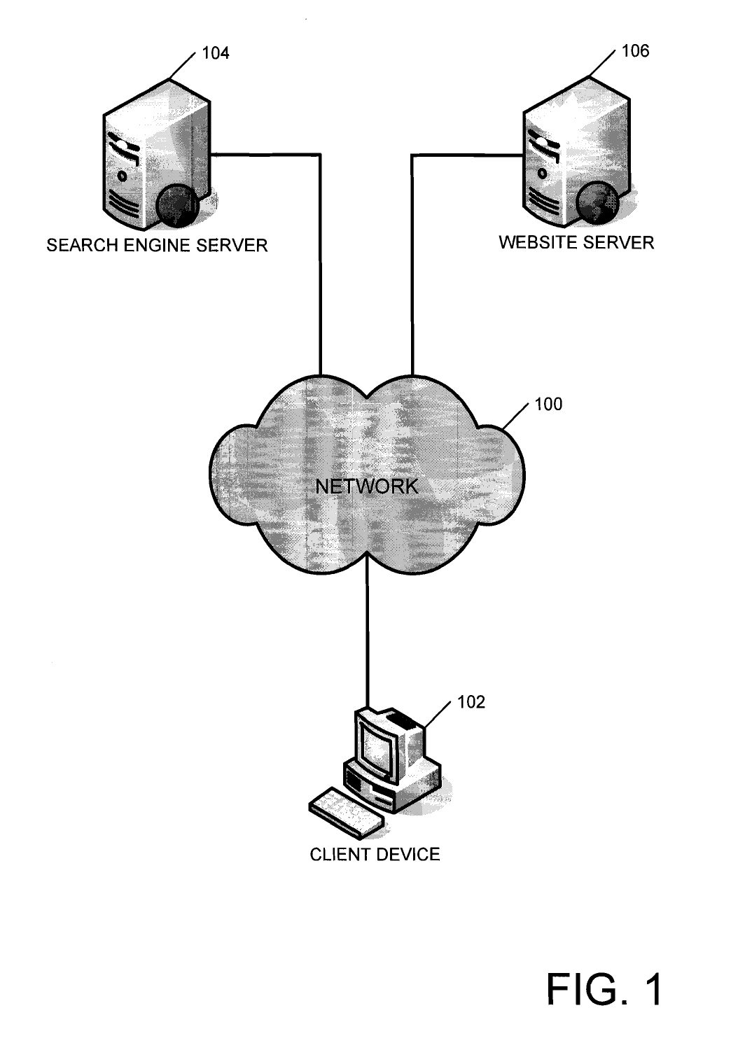

FIG. 1 is a network diagram illustrating exemplary components that may be implemented to provide a user with website data.

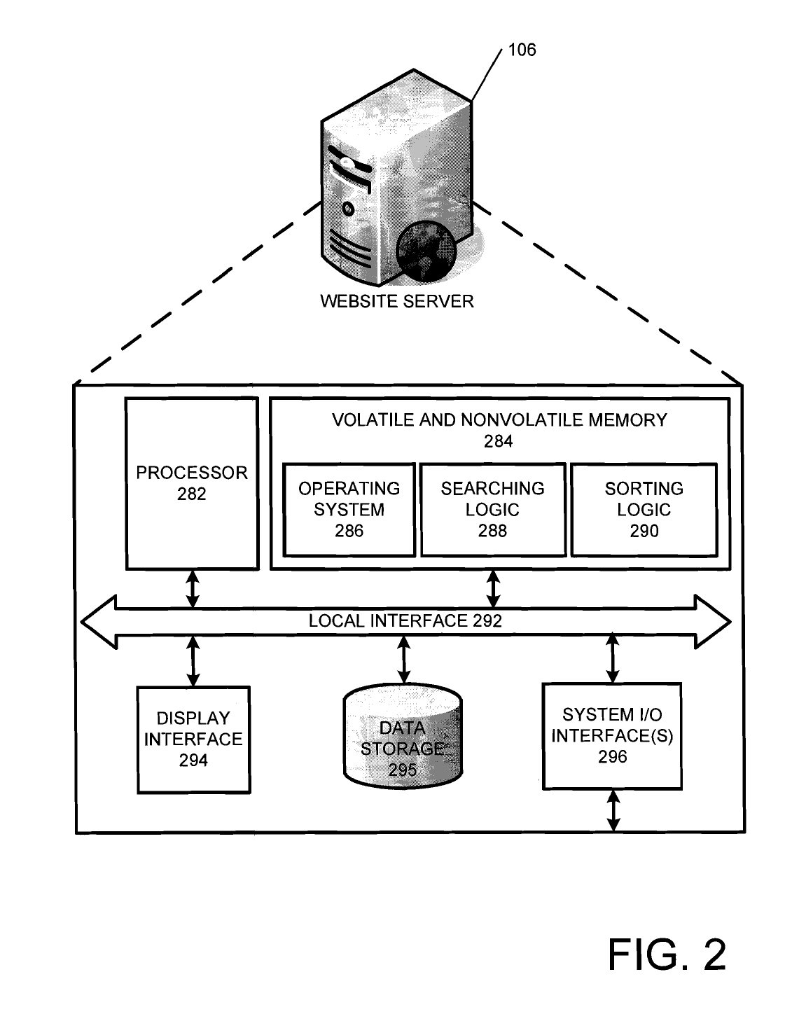

FIG. 2 is a block diagram illustrating exemplary components that may be associated with a client device, such as the client device from FIG. 1.

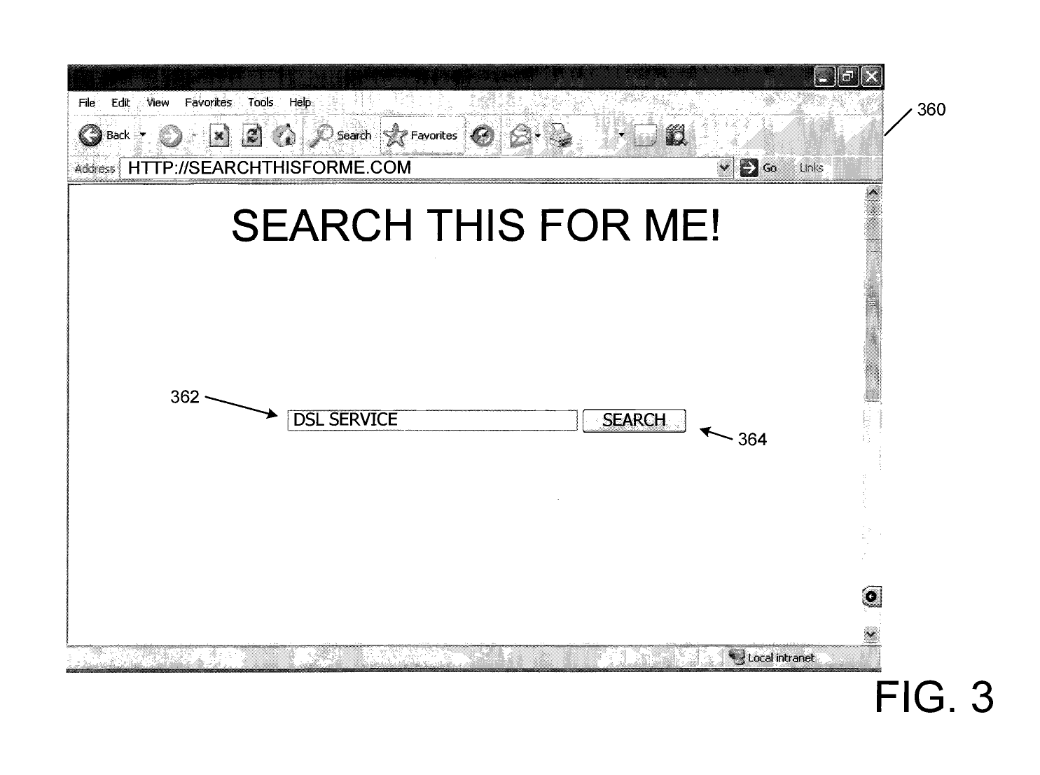

FIG. 3 is a nonlimiting example of a user interface, illustrating searching capabilities that may be provided by the search engine server from FIG. 1.

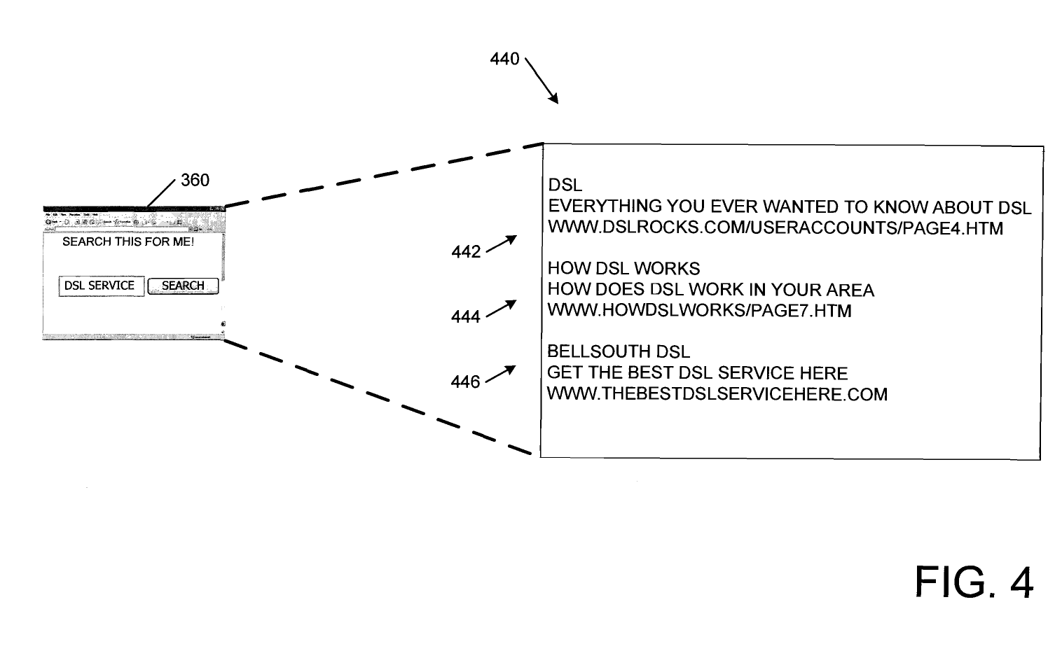

FIG. 4 is an exemplary embodiment of a user interface with associated search results from the search from FIG. 3.

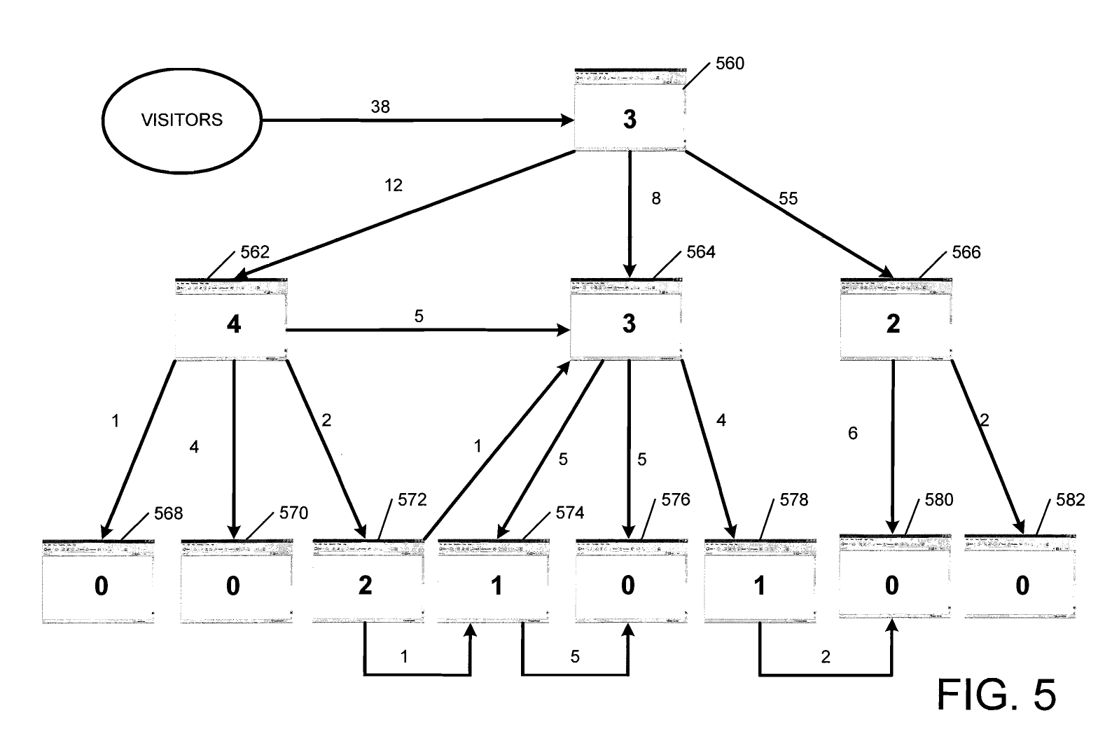

FIG. 5 is a nonlimiting example of a plurality of web pages that may be configured in a website such as from FIG. 2.

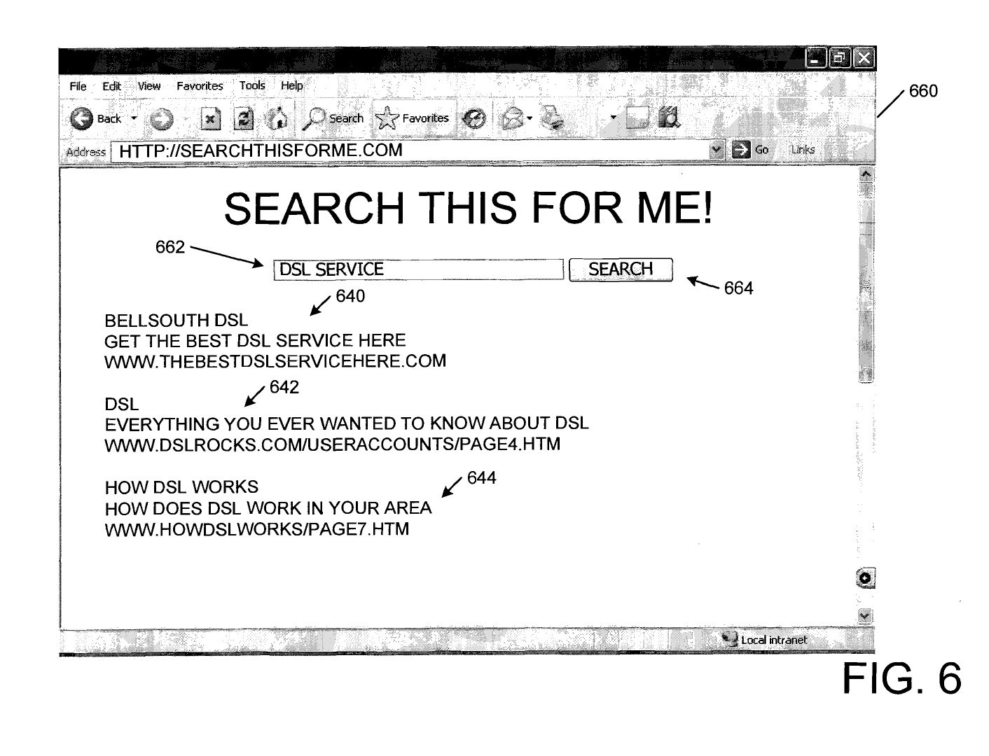

FIG. 6 is a nonlimiting example of a user interface that may be provided by the website server from FIG. 2.

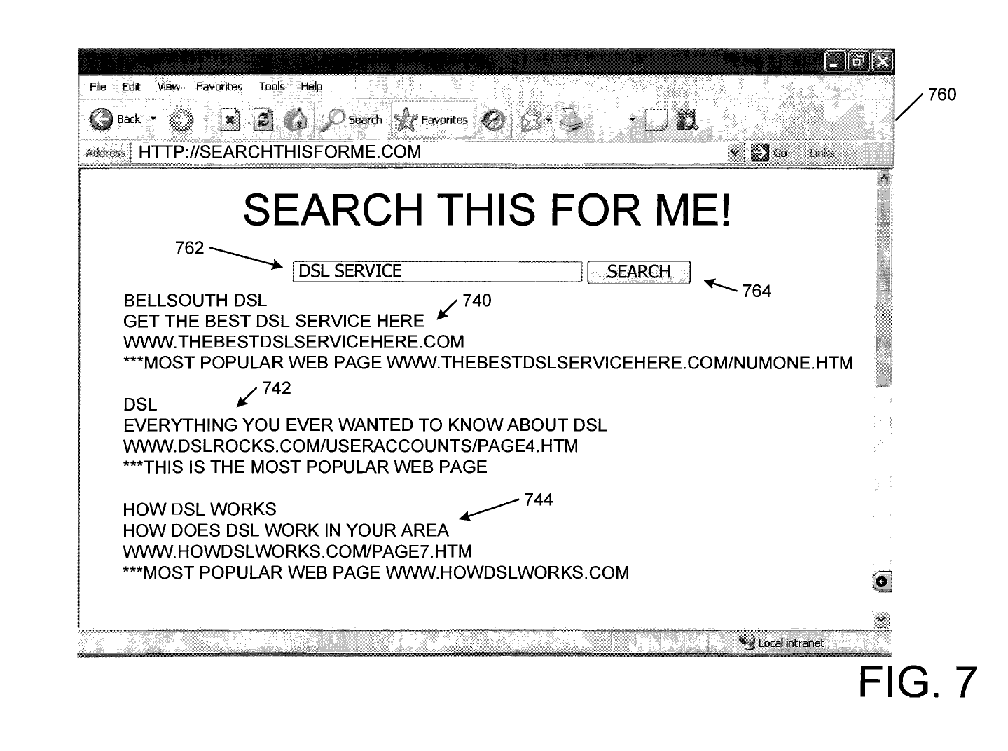

FIG. 7 is a nonlimiting example of a user interface that may be provided for searching one or more web pages, similar to the user interface from FIG. 6.

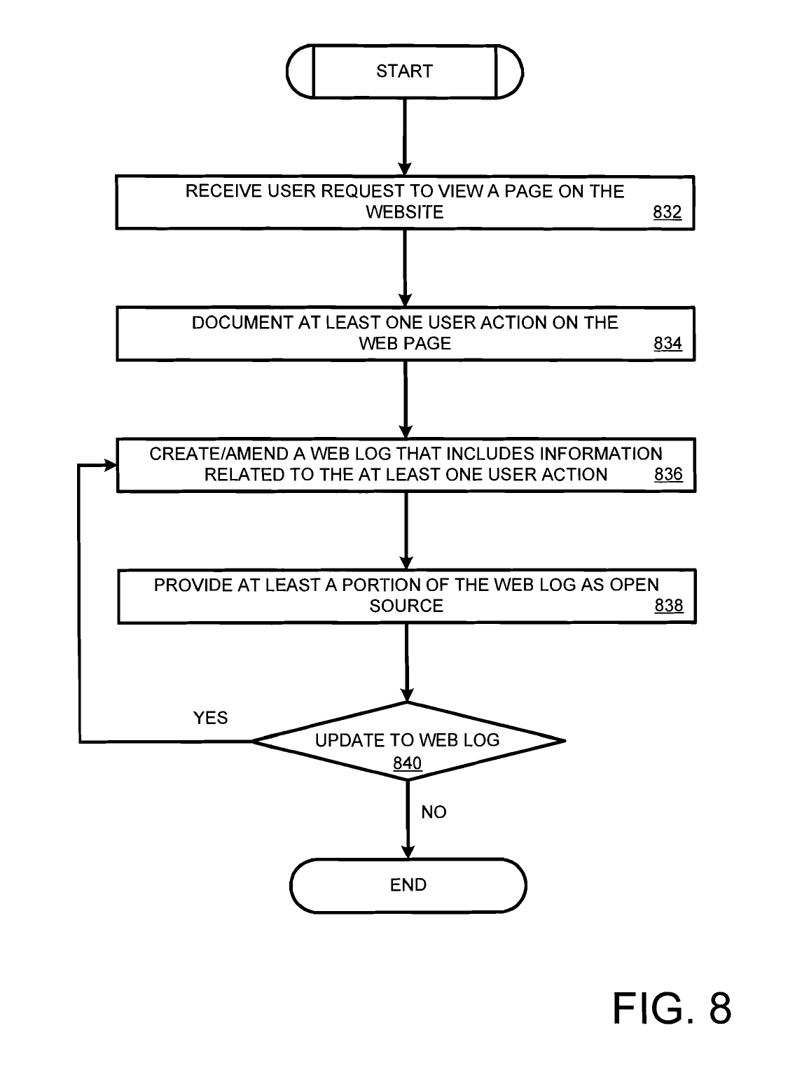

FIG. 8 is a flowchart illustrating an exemplary process that may be utilized for providing web page traffic data, such as to the search engine server from FIG. 1.

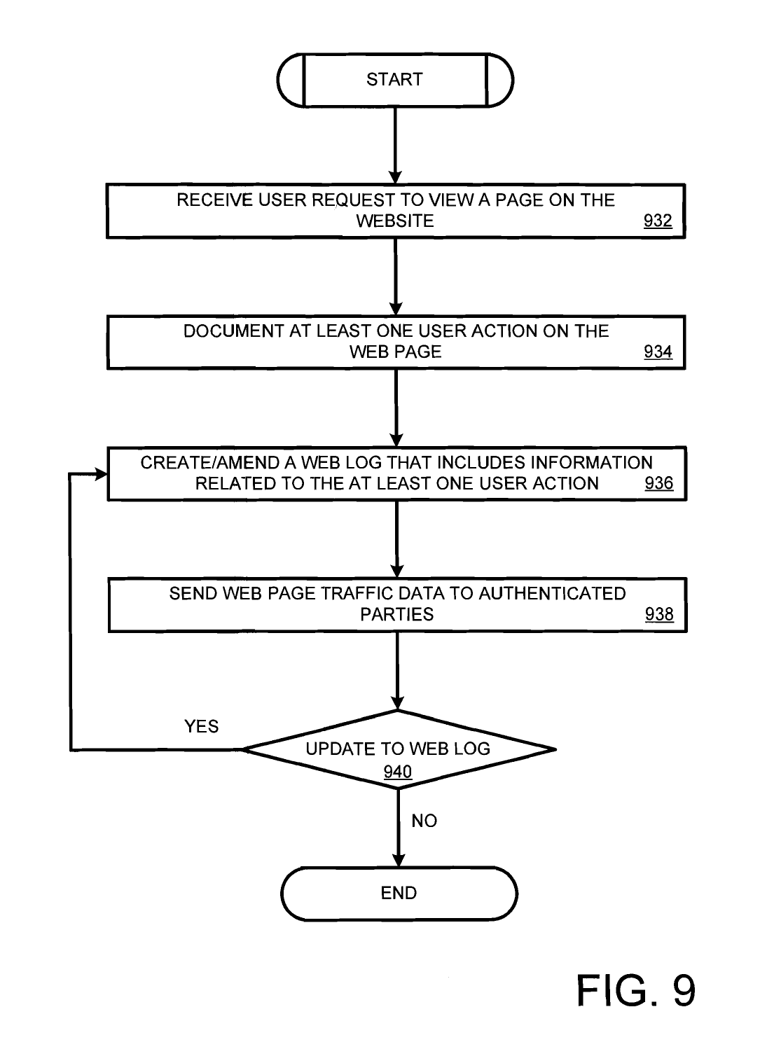

FIG. 9 is a flowchart illustrating an exemplary process that may be utilized for providing web page traffic data to an authenticated party, similar to the flowchart from FIG. 8.

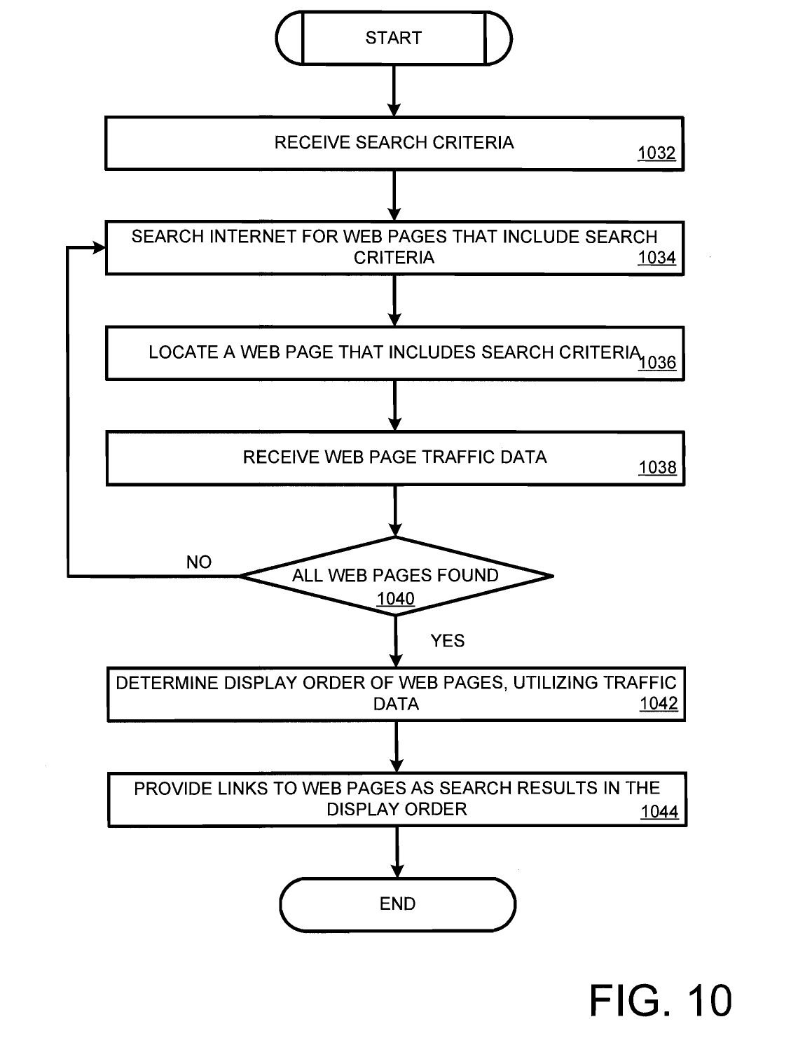

FIG. 10 is a flowchart illustrating an exemplary embodiment of a process for determining a display order for at least one web page, similar to the flowchart from FIG. 9.

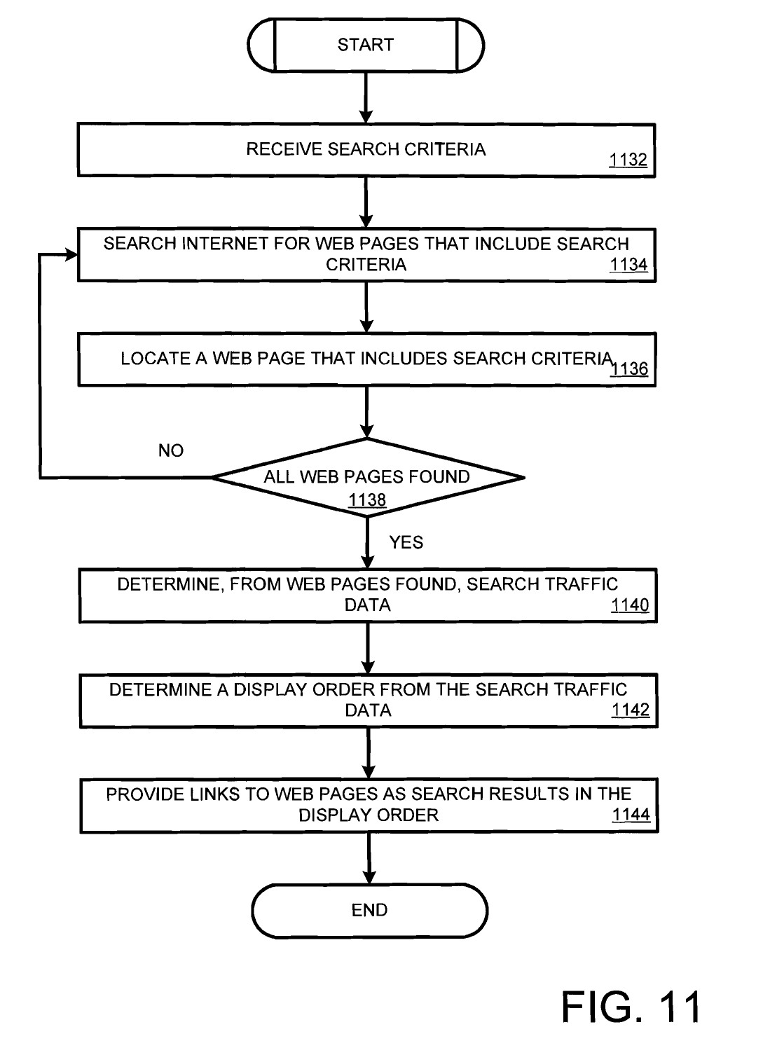

FIG. 11 is a flowchart illustrating an exemplary process for determining a display order from at least one previous search, similar to the flowchart from FIG. 10.

### DETAILED DESCRIPTION

FIG. 1 is a network diagram illustrating exemplary components that may be implemented to provide a user with website data. More specifically, the configuration from FIG. 1 illustrates a client device 102 coupled to a network 100, such as the Internet. Network 100 may also be coupled to a search engine server 104, as well as a website server 106. In operation, the client device 102 can access a network 100, which can act as a portal for data provided by the search engine server 104. The search engine server 104 can be configured to provide data related to a web page that allows the user of the client device 102 to enter search criteria related to desired subject matter. The search engine server 104 can then search other web pages associated with the network 100, according to the received search criteria. Upon completing the search, the search engine server 104 can provide data (which may take the form of source code) that includes an address associated with at least one of the web pages revealed in the search. Upon receiving the data, a web browser (and/or other logic) associated with the client device 102 can determine a format for displaying the received information. The user can then select at least one of the addresses. Upon receiving the user selection, the search engine server 104 can redirect the client device 102 to the website server 106, associated with the selected address.

One should note that although a single server is illustrated for representing the search engine server 104 and one for the website server 106, one or more servers, computers, etc. may be utilized to provide the desired functionality. Similarly, while the components of FIG. 1 are illustrated as having a wired connection to network 100, this is also a nonlimiting example. In at least one embodiment, one or more components may be wirelessly coupled to the network 100.

FIG. 2 is a block diagram illustrating exemplary components that may be associated with a website server, such as the website server 106, from FIG. 1. Although a wire-line client device is illustrated, this discussion can be applied to wireless devices, as well. Generally, in terms of hardware architecture, as shown in FIG. 2, server 106 includes a processor 282, volatile and nonvolatile memory 284, a display interface 294, a data storage 295, one or more input and/or output (I/O) device interface(s) 296, and/or one or more network interface that are communicatively coupled via a local interface 292. The local interface 292 can include, for example but not limited to, one or more buses and/or other wired and/or wireless connections. The local interface 292 may have additional elements, which are omitted for simplicity, such as controllers, buffers (caches), drivers, repeaters, and receivers to enable communications. Further, the local interface 292 may include address, control, and/or data connections to enable appropriate communications among the aforementioned components. The processor 282 may be a device for executing software, particularly software stored in volatile and nonvolatile memory 284. The processor 282 can include any custom made or commercially available processor, a central processing unit (CPU), an auxiliary processor among several processors associated with the server 106, a semiconductor based microprocessor (in the form of a microchip or chip set), a macroprocessor, and/or generally any device for executing software instructions.

The volatile and nonvolatile memory 284 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 284 may incorporate electronic, magnetic, optical, and/or other types of storage media. One should note that the volatile and nonvolatile memory 284 can have a distributed architecture (where various components are situated remote from one another), but can be accessed by the processor 282.

The software in volatile and nonvolatile memory 284 may include one or more separate programs, each of which includes an ordered listing of executable instructions for implementing logical functions. In the example of FIG. 2, the software in the volatile and nonvolatile memory 284 may include searching logic 288, sorting logic 290, as well as operating system 286. The operating system 286 essentially controls the execution of other computer programs and provides scheduling, input-output control, file and data management, memory management, and communication control and related services.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 284, so as to operate properly in connection with the operating system 286.

The Input/Output devices that may be coupled to system I/O Interface(s) 296 may include input devices, for example but not limited to, a keyboard, mouse, scanner, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more network interfaces (not shown) for facilitating communication with one or more other devices. More specifically, the network interface may include any component configured to facilitate a connection with another device. While in some embodiments, among others, the server 106 can include a network interface that includes a Personal Computer Memory Card International Association (PCMCIA) card (also abbreviated as “PC card”) for receiving a wireless network card, however this is a nonlimiting example. Other configurations can include the communications hardware within the computing device, such that a wireless network card is unnecessary for communicating wirelessly. Similarly, other embodiments include network interfaces 298 for communicating via a wired connection. Such interfaces may be configured with Universal Serial Bus (USB) interfaces, serial ports, and/or other interfaces.

If the server 106 includes a personal computer, workstation, or the like, the software in the volatile and nonvolatile memory 284 may further include a basic input output system (BIOS) (omitted for simplicity). The BIOS is a set of software routines that initialize and test hardware at startup, start the operating system 286, and support the transfer of data among the hardware devices. The BIOS is stored in ROM so that the BIOS can be executed when the server 106 is activated.

When the server 106 is in operation, the processor 282 may be configured to execute software stored within the volatile and nonvolatile memory 284, to communicate data to and from the volatile and nonvolatile memory 284, and to generally control operations of the server 106 pursuant to the software. Software in memory, in whole or in part, may be read by the processor 282, perhaps buffered within the processor 282, and then executed.

One should note that while the description with respect to FIG. 2 includes a server 106 as a single component, this is a nonlimiting example. More specifically, in at least one embodiment, the server 106 can include a plurality of servers, personal computers, and/or other devices. Similarly, while the description of FIG. 2 describes a server 106, this is also a nonlimiting example, as other components may also be included in this description, such as a search engine server 104, client device 102 and/or other components.

FIG. 3 is a nonlimiting example of a user interface 360, illustrating searching capabilities that may be provided by the search engine server 104 from FIG. 1. The user interface 360 includes searching options for a user to locate data on one or more web pages. More specifically, the user interface 360 may include a text prompt 362 and a search execution option 364 for initiating a search. In operation, a user may input search criteria in the text prompt 362 and select the search execution option 364. In response to receiving this data, a web browser component associated with the client device 102 sends the search criteria to the search engine server 104 (and/or website server 106, depending on the configuration). The server 104 and/or 106 can then compare the search criteria to data associated with one or more web pages on the Internet and/or Intranet.

In response to locating one or more web pages associated with the search criteria, the search engine server 104 can return more search results to the web browser. The web browser can then provide a user interface that includes the retrieved search results. The user may select one or more of the search results to access the desired information. As indicated above, while the search engine server 104 may provide a plurality of data related to the search criteria, in many configurations, this data may be unorganized and difficult for a user to determine relevancy to the search criteria.

FIG. 4 is an exemplary embodiment of a user interface with associated search results from the search from FIG. 3. As illustrated in the nonlimiting example of FIG. 4, a user has performed a search for the terms “DSL” and “Service.” In response, the search engine server 104 and/or website server 106 have searched the network 100 for the terms and metadata related to the search, and results from the search are displayed in a box 440. The box 440 includes search data related to results entitled “DSL” 442, “How DSL Works” 444, and “BellSouth DSL” 446. Additionally associated with the search results 442 is a description of the website and a URL associated with the search result. The description states “Everything you ever wanted to know about DSL,” as well as a URL that includes www.dslrocks.com/useraccounts/page4.htm. Similarly, the search result 444 includes a description “How DSL works in your area,” as well as a URL www.howdslworks/page7.htm. The search result 446 includes a description “Get the best DSL service here” and a URL www.thebestdslservicehere.com. While a search result may be found by any of a plurality of algorithms, a sort order of the search results, according to exemplary embodiments, is discussed in FIG. 5.

FIG. 5 is a nonlimiting example of a plurality of web pages that may be configured in a website such as may be provided by the website server 106 from FIG. 2. As illustrated in the nonlimiting example of FIG. 5, a website may include one or more web pages. Web pages may be configured with a home page 560 that may link to other pages in the website such as web pages 562, 564 and 566. Similarly, the web page 562 may link to web pages 568, 570, 572, and 564. The web page 564 may link to web pages 574, 576, and 578. The web page 566 may link to web pages 580 and 582. The web page 572 may link to the web page 564 and the web page 574. The web page 574 may link to the web page 576. The web page 578 may link to the web page 580.

As discussed above, a search engine, such as the search engine server 104 may be configured to search the Internet and/or Intranet to determine search results based on received search criteria. Upon retrieving the search results, the search engine server 104 may be configured to determine a sort order, also referred to herein as a display order, for at least a portion of the search results. More specifically, in at least one configuration, the search engine server 104 may be configured to determine a display order based on the number of links a web page has to other web pages. As a nonlimiting example, the web page 564 links to the web page 574, the web page 576, and the web page 578, and thus has three pages to which it links. Similarly, the web page 562 links to web pages 568, 570, 572, and 564. Thus, the web page 562 includes links to four different pages and the web page 564 includes links to three different pages. If the search engine server 104 determines that such search results for a particular search include the web page 562 and the web page 564, with all other criteria being equal, the web page 562 might be rated higher due to the larger number of links to other pages.

While such a configuration may determine a display order for search results, some embodiments may be configured to determine a display order of search results based on other criteria. In at least one embodiment, the search engine server 104 may be configured to determine a display order (at least in part) based on the volume of web page traffic to a particular page. Referring to FIG. 5, the home page 560 has received 38 visits. Similarly, the web page 566 has received 55 visits. The web page 564 has received 14 visits. The web page 562 has received 12 visits. The web page 568 has received one visit. The web page 570 has received four visits. The web page 572 has received two visits. The web page 574 has received six visits. The web page 576 has received ten visits. The web page 578 has received four visits. The web page 580 has received eight visits. Finally, the web page 582 has received two visits.

In determining a display order, the search engine server 104 may compare the number of visits a web page has to other web pages revealed in the search. More specifically, in comparing the home page 560 with web page 566, the search engine server 104 may determine that the web page 566 should be placed higher in the display order because the web page 566 has received 55 hits, as opposed to the 38 hits of the web page 560.

Similarly, depending on the particular configuration, display order can be determined not simply by the number of visits a web page receives, but by other criteria. More specifically, a website may document any of a plurality of metrics related to website and/or web page usage. Examples of this traffic data include time spent on a web page, information entered to a web page, items purchased from a web page, position of a cursor on a web page, number of different users on a web page, and/or other criteria related to traffic to a web page.

FIG. 6 is a nonlimiting example of a user interface 660 that may be provided by the website server 106 from FIG. 2. As illustrated in the nonlimiting example of FIG. 6, a user interface 660 includes a search text prompt 662, as well as a search execution option 664. Additionally, the user interface 660 includes a plurality of search results 640, 642, and 644 that may be displayed. More specifically, as illustrated in FIG. 5, the search engine server 104 may retrieve one or more web pages associated with search criteria and determine a display order for the search results. In FIG. 6, the search result BellSouth DSL 640 was determined to be most relevant to the search criteria. Again referring back to FIG. 5, this search result may have been determined to have the highest volume of traffic when compared with the search results 642 and 644. Similarly, the search result 642, entitled “DSL,” has been determined to be more relevant to the search criteria (“DSL Service”) than the search result 644. As the search result 642 may have a higher volume of traffic than the search result 644, the search engine server 104 may determine that this search result is more relevant to the search criteria.

FIG. 7 is a nonlimiting example of a user interface 760 that may be provided for searching one or more web pages, similar to the user interface 660 from FIG. 6. As illustrated in the nonlimiting example of FIG. 7, a user interface 760 includes a text prompt 762 and a search execution option 764. Similar to FIG. 6, the user interface 760 also includes the search results 740, 742, and 744. However, in this nonlimiting example, the user interface 760 includes a most popular web page option associated with one or more of the search results 740, 742, 744. More specifically, the search result 740 includes an indication that the most popular web page associated with the search result 740 is the web page www.thebestdslservicehere.com/numone.htm. This data may have been received from the website associated with the search result 740 to provide users with the most popular information. Similarly, the search result 742 is illustrated as being the most popular web page associated with this website. One should note that while traffic volume may be a factor in determining a search display order, depending on the particular embodiment, the particular weight given to traffic volume may vary.

One should also note that, depending on the particular embodiment, traffic volume may be determined on a total traffic basis, on a moving average basis, and/or other factors. More specifically, in some embodiments, the search engine server 104 may desire to provide more weight to web pages that have recently (e.g., within the last two weeks or other time period) been viewed by users as opposed to websites that historically have been viewed by users but are currently not receiving much traffic.

FIG. 8 is a flowchart illustrating an exemplary process that may be utilized for providing web page traffic data, such as to the search engine server 104 from FIG. 1. As illustrated in the nonlimiting example of FIG. 8, the website server 106 (and/or search engine server 104) may be configured to receive a user request to view a web page on the website (block 832). The website server 106 may then determine at least one user action on the web page (block 834). More specifically, the website can document any of a plurality of different user actions related to accessing a web page on the website. Such metrics may include total number of users that visit a web page, total number of different users that visit a web page, average time spent on a web page, most time spent on a web page, user actions while on a web page, items purchased from a web page, and/or other data associated with user actions on a web page.

The server 104, 106 may then create and/or amend a web log and/or other document that includes information related to at least one user action (block 836). The server 104, 106 may then provide at least a portion of the web log as an open source document (block 838). More specifically, the server 104, 106 may provide the information related to the at least one user actions to one or more users of the Internet and/or Intranet. The server 104, 106 may then determine whether to update the web log (block 840). Updating the web log may be determined based on a predetermined time interval, changes to the user actions, and/or other criteria. If no update to the web log is desired, the flowchart may end.

FIG. 9 is a flowchart illustrating an exemplary process that may be utilized for providing web page traffic data to an authenticated party, similar to the flowchart from FIG. 8. As illustrated in the nonlimiting example of FIG. 9, the server 104, 106 may receive a user request to view a page on the website (block 932). The server 104, 106 may then document at least one user action on the web page (block 934). The server 104, 106 may then create and/or amend a web log (and/or other document) that includes information related to the at least one user action (block 936). The server 104, 106 may then send the web page traffic data to one or more authenticated parties (block 938).

More specifically, the server 104, 106 may be configured to determine a list of one or more authenticated parties to which a website server can provide the web page traffic data. An authenticated user may include the search engine server 104 for providing criteria for determining display order, as illustrated in FIGS. 6 and 7. The server 104, 106 may then determine whether there has been an update to the web log (block 940). If the web log has been updated, the process returns to block 936. If, on the other hand, the web log has not been updated, the process may end.

FIG. 10 is a flowchart illustrating an exemplary embodiment of a process for determining a display order for at least one web page, similar to the flowchart from FIG. 9. As illustrated in the nonlimiting example of FIG. 10, the server 104, 106 may receive search criteria (block 1032). The server 104, 106 may then search the Internet (and/or Intranet) for web pages that include the received search criteria (block 1034). The server 104, 106 may locate a web page that includes at least a portion of the search criteria (block 1036). The server 104, 106 may then receive web page traffic data associated with the located web page (block 1038). The search engine server 104 may then determine whether a desired number web pages associated with the search criteria have been found (block 1040). If a desired number of the web pages have not been found, the flowchart may return to block 1034. If, on the other hand, the server 104, 106 determines that all web pages are found, the server 104, 106 may determine a display order of the web pages, utilizing data related to the web page traffic (block 1042). The server 104, 106 may then provide one or more links to web pages as search results in the display order (block 1040).

FIG. 11 is a flowchart illustrating an exemplary process for determining a display order from at least one previous search, similar to the flowchart from FIG. 10. As illustrated in the nonlimiting example of FIG. 11, the server 104, 106 may receive search criteria (block 1132). The server 104, 106 may then search the network 100 for web pages that include the received search criteria (block 1134). The server 104, 106 may then locate a web page that includes at least a portion of the search criteria (block 1136). The server 104, 106 may then determine whether all desired web pages associated with the search criteria have been found (block 1138). If the server 104, 106 determines that all web pages have not been found, the flowchart may return to block 1134.

If, on the other hand, the server 104, 106 determines that all desired web pages associated with the search criteria have been found (and/or a desired number of search results are found), the server 104, 106 may determine, from the web pages found, search traffic data (block 1140). More specifically, the server 104, 106 may determine the amount of the traffic volume associated with the search results based on similar previous searches. As a nonlimiting example, referring back to FIG. 6, if the server 104, 106 determines that users searching for the search criteria “DSL service” often select the search result 640 (as opposed to search result 642 and/or 644), the server 104, 106 may provide greater weight to the search result 640 in a subsequent search. Additionally, depending on the particular embodiment, this information may be combined with other traffic volume data that may be received from the website server 106 and/or other data associated with the relevance of one or more search results. The server 104, 106 may then determine a display order from the search traffic data (block 1142). The server 104, 106 may then provide links to web pages as search results in the display order (block 1144).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for determining a sort order, comprising:
determining at least one search result from received search criteria, the at least one search result being related to a first web page;
determining web page traffic data associated with the first web page, the web page traffic data being related to at least one user action associated with the first web page; and
determining the sort order for the at least one search result from the web page traffic data.

2. The method of claim 1, further comprising providing the at least one search result in the sort order.

3. The method of claim 1, further comprising:
receiving web page traffic data associated with a second web page, the second web page being different than the first web page, the second web page being associated with the at least one search result;
determining whether the second web page has previously received a larger amount of web page traffic than the first web page; and
in response to determining that the second web page has previously received a greater amount of web page traffic than the first web page, providing an option to view the second web page.

4. The method of claim 1, wherein the web page traffic data is provided via open source code.

5. The method of claim 1, further comprising providing an identification for receiving at least a portion of the web page traffic data.

6. The method of claim 1, wherein determining the web page traffic data includes receiving web page traffic data from a website server associated with the search result.

7. The method of claim 1, wherein determining the web page traffic data includes determining whether the at least one search result is a frequently viewed search result.

8. A server for determining a sort order, the server configured to:
determine at least one search result from received search criteria, the at least one search result being related to a first web page;
determine web page traffic data associated with the first web page, the web page traffic data being related to at least one user action associated with the first web page; and
determine the sort order for the at least one search result from the web page traffic data.

9. The server of claim 8, wherein the server is further configured to provide at least one search result in the sort order.

10. The server of claim 8, wherein the server is further configured to:
receive web page traffic data associated with a second web page, the second web page being different than the first web page, the second web page being associated with the at least one search result;
determine whether the second web page has previously received a larger amount of web page traffic than the first web page; and
in response to determining that the second web page has previously received a greater amount of web page traffic than the first web page, provide an option to view the second web page.

11. The server of claim 8, wherein the web page traffic data is provided via open source code.

12. The server of claim 8, wherein the server is further configured to provide an identification for receiving at least a portion of the web page traffic data.

13. The server of claim 8, wherein the server is further configured to receive web page traffic data from a website server associated with the search result.

14. The server of claim 8, wherein the server is further configured to determine whether the at least one search result is a frequently viewed search result.

15. A computer readable medium for determining a sort order, comprising:
result determining logic configured to determine at least one search result from received search criteria, the at least one search result being related to a first web page;
traffic determining logic configured to determine web page traffic data associated with the first web page, the web page traffic data being related to at least one user action associated with the first web page; and
order determining logic configured to determine a sort order for the at least one search result from the web page traffic data.

16. The computer readable medium of claim 15, further comprising result providing logic configured to provide at least one search result in the sort order.

17. The computer readable medium of claim 15, further comprising:
receiving logic configured to receive web page traffic data associated with a second web page, the second web page being different than the first web page, the second web page being associated with the at least one search result;
amount determining logic configured to determine whether the second web page has previously received a larger amount of web page traffic than the first web page; and
option providing logic configured to, in response to determining that the second web page has previously received a greater amount of web page traffic than the first web page, provide an option to view the second web page.

18. The computer readable medium of claim 15, wherein the web page traffic data is provided via open source code.

19. The computer readable medium of claim 15, further comprising identification providing logic configured to provide an identification for receiving at least a portion of the web page traffic data.

20. The computer readable medium of claim 15, wherein the traffic determining logic is further configured to receive web page traffic data from a website server associated with the search result.
